(19) United States
(12) Patent Application Publication
(10) Pub. No.: US 2018/0160633 A1
(43) Pub. Date: Jun. 14, 2018

(54) Planter Cover Apparatus

(71) Applicant: Geno Francis DeLao, Denver, CO (US)

(72) Inventor: Geno Francis DeLao, Denver, CO (US)

(21) Appl. No.: 15/837,385

(22) Filed: Dec. 11, 2017

Related U.S. Application Data
(60) Provisional application No. 62/432,649, filed on Dec. 11, 2016.

(51) Int. Cl. A01G 13/04

(52) U.S. Cl. CPC A01G 13/043; A01G 2013/0218

(57) ABSTRACT

A planter cover apparatus for a plant and pot, the apparatus includes a surrounding sidewall that has first and second end portions, plus removably engagable first and second margin portions that all act to define a primary interior that the plant is disposed within. The first and second margins form a first aperture and a sidewall first end with an elastic band forms a second aperture that is about the pot. Also included is an extension element having proximal and opposing distal end portions wherein the extension element is affixed to the sidewall with the extension element secured to the pot. Wherein operationally, the elastic band removably engages the pot and the extension element provides support for the sidewall about the plant resulting in protection of the plant from adverse weather, further operationally the cover apparatus is removable from the plant via the first aperture or the second aperture.

### RELATED PATENT APPLICATION

This application claims the benefit of U.S. provisional patent application Ser. No. 62/432,649 filed on Dec. 11, 2016 by Geno Francis DeLao of Denver, Colo., U.S.

### FIELD OF THE INVENTION

The present invention generally relates to protective covers for plants. More particularly, the present invention discloses removable protective covers for potted and in ground plants.

### DESCRIPTION OF THE RELATED ART

Up until now there have been relatively moderate efforts in designing and manufacturing a fully engineered protective cover for plants, a number of the current protective covers available for plants protection to the consumer appear to be design afterthoughts in that they are nothing any more special than a piece of fabric draped over a wire frame, being similar to an ultra lightweight camping tent that is miniaturized. The typical protective cover has a zippered enclosure with a nylon type fabric cover, wherein the protective cover loosely fits around the plant pot.

The current other protective cover materials available are typically various forms of very thin sheet material that has as a primary purpose is for frost protection or pest (animal) protection and not for either a hard rain or hailstones, i.e. most of these current plant covers are far too thin and weak to withstand a hard rain or hailstones to protect the plant. Most currently available are thin and lightweight plant covers at the very best only moderately protect the plant, this being primarily due to the frame and protective cover materials being inherently soft and flexible and also fitting around the outer surface of the plant in a very loose manner, due to the protective cover attempting to fit a wide variety of plant sizes.

What this results in that if a large fast moving rain storm or larger hailstones come in a storm that are often accompanied by strong winds comes in contact with the currently available protective plant covers, the cover firstly will not have any structural rigidity to resist any sort of point impact to protect the plant, and secondly with the hard winds the plant cover could completely be blown off of the plant, thus leaving the plant completely unprotected.

Therefore, two very basic desirable things come to light to maximize the protection given to the plant. The first desirable thing is “structural rigidity”, in other words the protective cover should be able to handle a point load impact (from hailstones & hard rain) and be able to handle a bending load imposed upon the cover from a hard wind. Wherein the aforementioned point load impact and bending load are placed upon the exterior of the protective cover, the protective cover would have the rigidity to absorb the brunt of this external loading by being its own rigid structure, thus not transmitting these external protective cover loads to the plant itself. The second desirable thing for the protective cover is to have a very snug and close-fitting fit to either the exterior surface of the plant pot or be adequately anchored to the surface, whether be a ground surface, patio surface, or even a rooftop.

The well-known problem to accomplishing the above two mentioned things for a protective plant cover typically requires a totally custom made hard shell enclosure, noting that some plant covers don't even have a frame at all, such that the fabric merely wraps about the plant structure itself, with the plant structure giving support, shape, and strength to the flexible soft plant cover. To address the close fitting requirement, the prior art has had solutions such as wrapping the fabric around the plant itself or have a lightweight small tent type frame that are almost disposable in nature.

Looking at the plant cover prior arts, in U.S. Pat. No. 9,326,455 to McClay, disclosed is a plant container cover and insulation that is a clam shell arrangement that is matched to the plant container, wherein the cover in McClay is a hard shell that has good protective qualities, however, with the drawback being that the cover required a matched plant container.

Further, in the plant cover prior arts, in U.S. Pat. No. 8,615,924 to Dinihanian, Jr., disclosed is a collapsible “A” frame green house cover, wherein the primary goal of Dinihanian is for tall vegetable/fruit plant support with the option of a fabric cover. Dinihanian does not teach surface anchoring and would not be stable in high winds or a hard rain or hailstorm.

Continuing in the plant cover prior arts, in U.S. Pat. No. 7,266,925 to Weder, disclosed is a Pot having a plant cover secured thereto, wherein the pot cover has heat shrink material to secure about the plant pot, wherein the cover extends to an inverted frustroconical shape with a top fold over cover. Weder is designed for plant packaging for shipping and once the plant has arrived at its destination the cover can be peeled back to expose the plant for showing, wherein Weder is not designed to protect the plant from adverse weather conditions.

Further, in the plant cover prior arts, in U.S. Pat. No. 6,088,953 to Morgan, disclosed is a collapsible protective plant cover that is cylindrically shaped being constructed of a center pole with a pair of spring steel rings at the top and bottom of the cylinder, wherein the cylinder sidewall in constructed of a flexible and collapsible fabric material. Morgan does not teach significant anchoring into the surface and with the soft fabric cylinder and would not be that effective as against adverse weather such as hard rain, high winds, and hailstones.

Next, in the plant cover prior arts, in U.S. Pat. No. 5,540,014 to Smith, disclosed is a plant cover that is constructed of a kit of rigid parts of plastic that are assembled in various configurations that are variety of shapes including symmetric, elongated, “L” shaped, and so on, with some anchor pins driven into the ground. The novelty in Smith is in the interconnecting flange margins as between the plastic parts that facilitate the multiple configurations of shapes to provide a fairly rigid protective cover for plants from adverse weather, however, a detriment to Smith would be in the time consumed in assembling and disassembling the rigid parts which could be cumbersome, plus having to deal with tools and attachment hardware.

What is needed is a protective cover that accomplishes is two very basic desirable things to maximize the physical impact protection given to the plant. The first desirable thing is “structural rigidity”, in other words the protective cover must be able to handle a point load impact and be able to handle a bending load imposed upon the plant along its longest axis from high winds. Wherein, the aforementioned point load impact and bending load are placed upon the exterior of the protective cover, wherein the protective cover will absorb stand up to the brunt of this external loading by being its own rigid structure, thus not transmitting these external protective cover loads to the plant itself or at least shielding the majority of the external loading from the plant. The second desirable thing for the protective cover is to have a very snug and close-fitting fit to the exterior surface of the plant, that minimizes the relative movement of the plant in the protective cover during high winds, hailstones, or hard rain weather conditions.

Therefore the challenge of the present invention is to have a protective cover apparatus that can custom fit itself to a multitude of different size plants and to have the structural rigidity necessary to adequately protect the plant, while at the same time having the ability to be used with a number of different sizes of plant and being desirably flexible for relatively easy storage and handling when the protective cover apparatus of the present invention does not have an plant disposed within it. Further the protective cover apparatus would be relatively easy to place around the plant and to remove from the plant.

### SUMMARY OF INVENTION

Broadly, the present invention is a planter cover apparatus for a plant with a pot, the apparatus includes a flexible surrounding sidewall that is about a longitudinal axis, wherein the surrounding sidewall has a first end portion and an opposing second end portion wherein the longitudinal axis is spanning therebetween. The surrounding sidewall also having a first margin portion and an opposing second margin portion, wherein the first and second margin portions are substantially parallel to the longitudinal axis, the surrounding sidewall also having an outer surface portion that is adjacent to an external environment and an inner surface portion that defines a primary interior formed by the sidewall, the second end portion, and the first and second margins. Wherein the outer surface portion is attached at the second end portion further forming the primary interior that the plant is disposed within, wherein the second margin portion at the outer surface and the first and second margin portions are removably engagable to one another and define a first aperture opening, further a second aperture is disposed therethrough the first end portion sidewall allowing the pot to pass therethrough from the primary interior into the external environment.

Also included on the planter cover apparatus is an extension element having a lengthwise axis, the extension element having a proximal end portion and an opposing distal end portion with the lengthwise axis spanning therebetween. The extension element is affixed to the flexible surrounding sidewall as between the flexible surrounding sidewall first end portion at the proximal end portion and the flexible surrounding sidewall second end portion at the distal end portion, further the proximal end portion is secured adjacent to the pot.

Further included in the planter cover apparatus is an elastic band that is affixed to the flexible surrounding sidewall first end portion wherein the elastic band extends outward from the first end portion. Wherein operationally, the elastic band removably engages the pot and the extension element provides support for the flexible surrounding sidewall about the plant resulting in assisting in protection of the plant from adverse weather in the external environment, further operationally the cover apparatus is removable from the plant via the first aperture or the second aperture.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a cross sectional view of the planter cover apparatus wherein the cross section is taken from cross section cut 1-1 in FIG. 3, FIG. 1 shows an external environment, a plant, a pot, a flexible surrounding sidewall, a longitudinal axis for the sidewall, an inner surface and outer surface of the sidewall, a primary interior of the sidewall, first and second margins removably engagable to one another, with an extension element that is operational to support the sidewall, further an elastic band that is affixed to the sidewall and that removably engages the pot, also noting that a first and a second apertures are both in a closed state;

FIG. 2 shows a cross sectional view of the planter cover apparatus wherein the cross section is taken from cross section cut 2-2 in FIG. 3 being ninety degrees apart in relation to the FIG. 1 cross section, FIG. 2 shows the external environment, the plant, the pot, the flexible surrounding sidewall, the longitudinal axis for the sidewall, the inner surface and outer surface of the sidewall, the primary interior of the sidewall, first and second margins removably engagable to one another, with the extension element that is operational to support the sidewall, further the elastic band that is affixed to the sidewall and that removably engages the pot, also noting that the first and the second apertures are both in the closed state;

FIG. 3 shows an overhead elevation view of the planter cover apparatus wherein FIG. 3 is taken from view 3-3 in FIG. 1 being the overhead elevation view, FIG. 3 shows the external environment, the flexible surrounding sidewall, the longitudinal axis for the sidewall, the outer surface of the sidewall, the first and second margins removably engagable to one another, with the extension element that is operational to support the sidewall, also noting that the first aperture is in the closed state;

FIG. 4 shows an overhead elevation view of the planter cover apparatus wherein FIG. 4 is taken from view 4-4 in FIG. 1 being the overhead elevation view, FIG. 4 shows the external environment, the plant, the elastic band, the flexible surrounding sidewall, the longitudinal axis for the sidewall, the outer and inner surfaces of the sidewall, the first and second margins removably engagable to one another, with the extension element that is operational to support the sidewall, also noting that the first aperture is in the open state;

FIG. 5 shows a side elevation view of a first alternative embodiment of the planter cover apparatus that shows the external environment the plant, the pot, a partial sidewall, a longwise axis, wherein the partial sidewall includes a primary margin and a secondary margin that are removably engagable to one another in a closed state, further a beam is shown that supports the partial sidewall, and a support structure from the pot to the partial sidewall;

FIG. 6 shows an upper elevation view of the first alternative embodiment of the planter cover apparatus that shows the external environment the plant, the pot, the partial sidewall, the longwise axis, wherein the partial sidewall includes the primary margin and the secondary margin that are removably engagable to one another in the closed state, further the beam is shown that supports the partial sidewall;

FIG. 7 shows a side elevation view of the planter cover apparatus that shows the external environment, the flexible surrounding sidewall, the longitudinal axis for the sidewall, the outer surface of the sidewall, the first and second margins that are removably engagable to one another shown in the closed state, also noting that the first aperture is in the closed state;

FIG. 8 shows a side elevation cross sectional view of the planter cover apparatus as shown in FIG. 7, wherein the FIG. 8 cross section shows the external environment, the plant, the pot, the flexible surrounding sidewall, the longitudinal axis for the sidewall, the inner surface and the outer surface of the sidewall, the primary interior of the sidewall, first and second margins removably engagable to one another in the closed state, with the extension element that is operational to support the sidewall, also noting that the first and second apertures are in the closed state;

FIG. 9 shows a side elevation view of a second alternative embodiment of the planter cover apparatus that shows the external environment, a flexible wall, wherein the flexible wall includes a leading margin and a trailing margin that are removably engagable to one another shown in a closed state, further a support element is shown that supports the flexible wall, and ground stakes inserted into a ground surface; and

FIG. 10 shows an upper perspective elevation view of the second alternative embodiment of the planter cover apparatus that shows the external environment, the flexible wall, wherein the flexible wall includes the leading margin and the trailing margin that are removably engagable to one another shown in the closed state, further the support element is shown that supports the flexible wall, and ground stakes inserted into the ground surface.

### REFERENCE NUMBERS IN DRAWINGS

50 Planter cover apparatus
55 Exterior environment
60 Plant
65 Pot for the plant 60
70 Flexible surrounding sidewall
75 Longitudinal axis of the surrounding sidewall 70
80 First end portion of the surrounding sidewall 70
85 Second end portion of the surrounding sidewall 70
90 First margin portion of the surrounding sidewall 70
95 Second margin portion of the surrounding sidewall 70
100 Substantially parallel position of the first 90 and second 95 margins to the longitudinal axis
105 Outer surface portion of the surrounding sidewall 70
110 Inner surface portion of the surrounding sidewall 70
115 Primary interior of the surrounding sidewall 70
120 Outer surface portion attached at the second end portion 85
125 First 90 and second 95 margin portions being removably engagable to one another
130 First aperture opening defined by the first 90 and second 95 margin portions removable engagement 125
131 First aperture 130 in a closed state
132 Second aperture 135 in a closed state
133 Second aperture 135 in a open state
134 First aperture 130 in a open state
135 Second aperture that is disposed therethrough the first end portion 80 of the surrounding sidewall 70
140 Pot passing therethrough from the primary interior 115 into the external environment 55
145 Extension element
150 Lengthwise axis of the extension element 145
155 Proximal end portion of the extension element 145
160 Distal end portion of the extension element 145
165 Extension element 145 affixed to the flexible surrounding sidewall 70 first end portion 80 at the proximal end portion 155
170 Extension element 145 affixed to the flexible surrounding sidewall 70 second end portion 85 at the distal end portion 160
175 Proximal end portion secured adjacent to the pot 140
180 Extension element 145 provides support for the surrounding sidewall 70
185 Elastic band
190 Elastic band 185 affixed to the first end portion 80 of the surrounding sidewall 70
195 Elastic band 185 extends outward from the first end portion 80 of the surrounding sidewall
200 Elastic band 185 removably engages the pot 65
205 Plant cover apparatus 50 is removable from the plant 60 via the first aperture 130
210 Plant cover apparatus 50 is removable from the plant 60 via the second aperture 135
300 First alternate embodiment of the plant cover apparatus
305 Partial sidewall, preferably being dome, or hood type protection for the plant 60
310 Longwise axis
315 Primary margin
320 Secondary margin
325 Beam
326 Affixed beam 325 to partial sidewall 305
330 Support structure
400 Second alternate embodiment of the plant cover apparatus
405 Flexible wall preferably having a dome shape
410 Leading margin
415 Trailing margin
420 Support element
421 Frame structure
425 Ground stake extension
426 Proximal end portion of the frame structure 421
427 Distal end portion of the frame structure 421
428 Affixed frame 421 to flexible wall 405
430 Ground surface
435 Removably engagable structure that can include a zipper, hook and loop fastener, buckles, groove and ridge interlock, snap connectors, buttons, ties, snaps, double “D” rings, hooks, and the like
440 Extension element 145 that can be an elongated beam, support structure 330, or frame structure 421 in the form of a cross section of an angle beam, a channel beam, an “I” beam, a solid rod, a tube, or the like
445 Closed end portion of the partial sidewall 305
450 Open end portion of the partial sidewall 305
455 Outer surface of the partial sidewall 305
460 Inner surface of the partial sidewall 305
465 Partial interior of the partial sidewall 305
470 Third aperture of the partial sidewall 305
475 Open state of the third aperture 470
480 Closed state of the third aperture 470
485 Proximal end portion of the support structure 330
490 Distal end portion of the support structure 330
495 Flexible element
500 Closed end portion of the flexible wall 405
505 Open end portion of the flexible wall 405
510 Dome interior
515 Fourth aperture
520 Open state of the fourth aperture 515
525 Closed state of the fourth aperture 515

### DETAILED DESCRIPTION

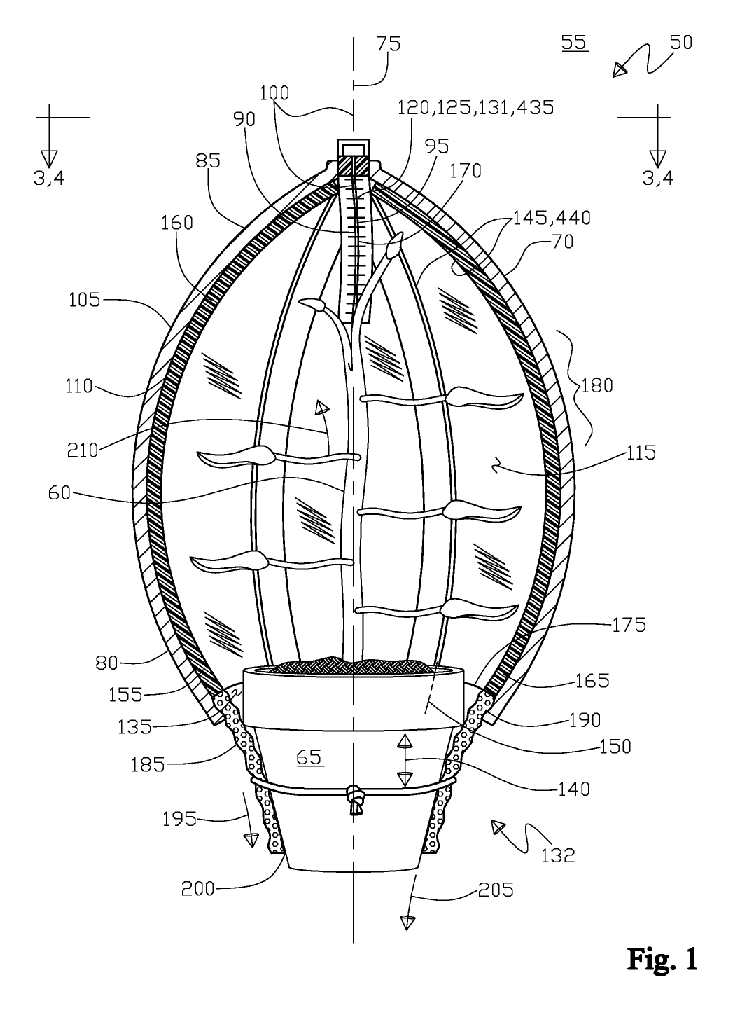

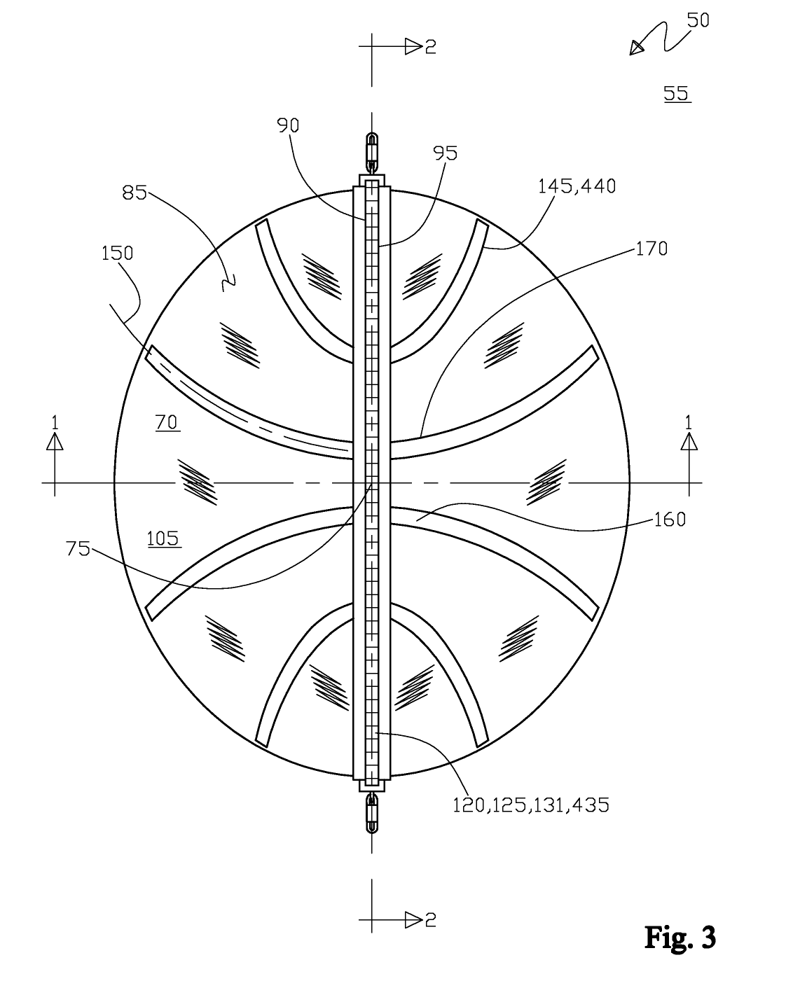

With initial reference to FIG. 1 shown is a cross sectional view of the planter cover apparatus 50 wherein the cross section is taken from cross section cut 1-1 in FIG. 3, FIG. 1 shows an external environment 55, a plant 60, a pot 65, a flexible surrounding sidewall 70, a longitudinal axis 75 for the sidewall 70, an inner surface 110 and outer surface 120 of the sidewall 70, a primary interior 115 of the sidewall 70, first 90 and second 95 margins removably engagable 125 to one another. Further, FIG. 1 shows an extension element 145 that is operational to support 180 the sidewall 70, also an elastic band 185 that is affixed 190 to the sidewall 70 and that removably engages 200 the pot 65, also noting that a first 130 and a second 135 apertures are in a closed state 131, 132 respectively.

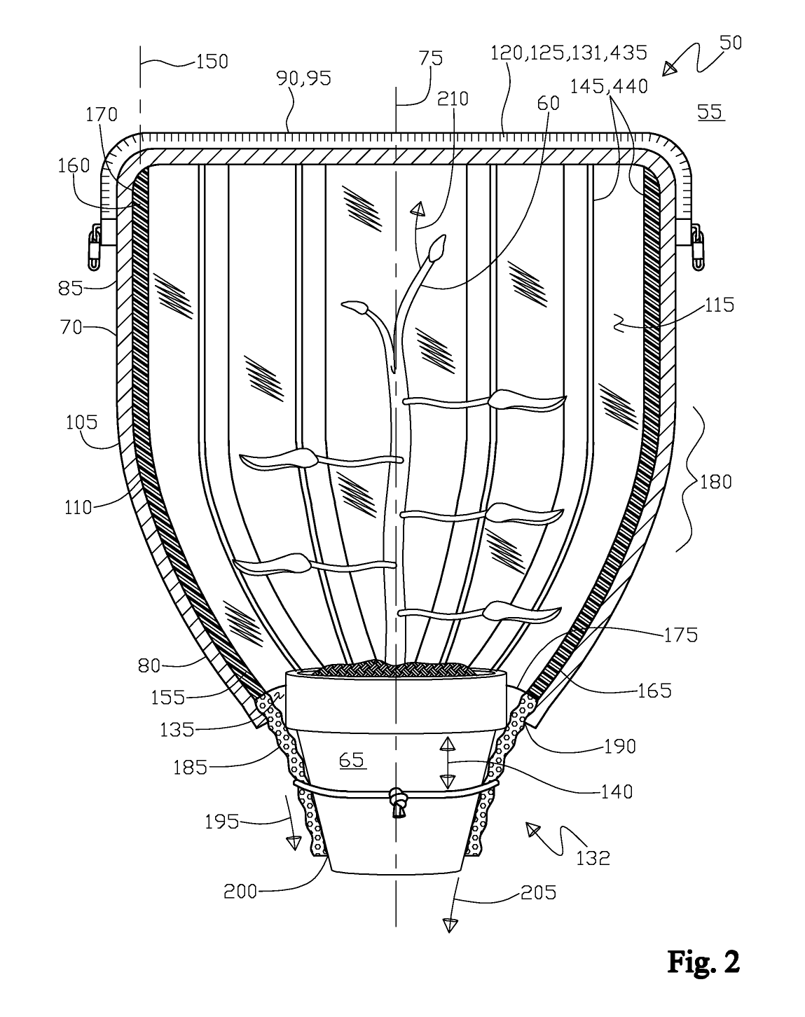

Continuing, FIG. 2 shows a cross sectional view of the planter cover apparatus 50 wherein the cross section is taken from cross section cut 2-2 in FIG. 3 being ninety degrees apart in relation to the FIG. 1 cross section, FIG. 2 shows the external environment 55 the plant 60, the pot 65, the flexible surrounding sidewall 70, the longitudinal axis 75 for the sidewall 70, the inner surface 110 and outer surface 120 of the sidewall 70, the primary interior 115 of the sidewall 70, first 90 and second 95 margins removably engagable 125 to one another. In addition, FIGS. 2 shows the extension element 145 that is operational to support 180 the sidewall 70, further the elastic band 185 that is affixed 190 to the sidewall 70 and that removably engages 200 the pot 65, also noting that the first 130 and the second 135 apertures are in the closed state 131, 132 respectively.

Further, FIG. 3 shows an overhead elevation view of the planter cover apparatus 50 wherein FIG. 3 is taken from view 3-3 in FIG. 1 being the overhead elevation view, FIG. 3 shows the external environment 55, the flexible surrounding sidewall 70, the longitudinal axis 75 for the sidewall 70, the outer surface 120 of the sidewall 70, the first 90 and second 95 margins removably engagable 125 to one another, with the extension element 145 that is operational to support 180 the sidewall 70, also noting that the first aperture 130 is in a closed state 131.

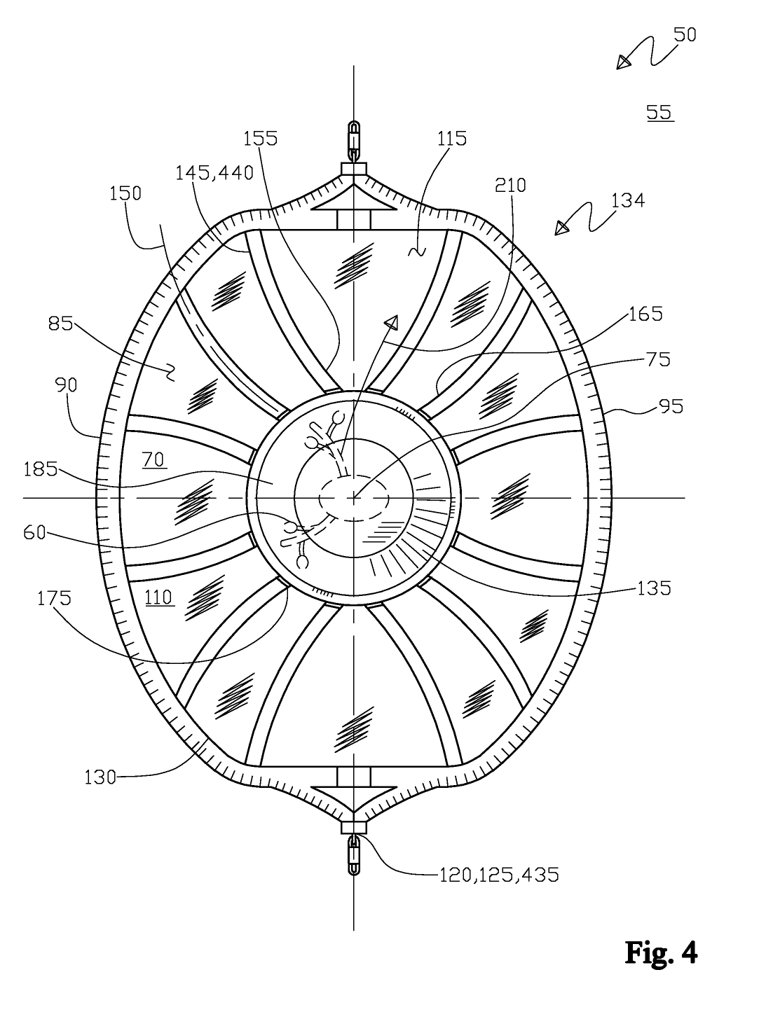

Moving onward, FIG. 4 shows an overhead elevation view of the planter cover apparatus 50 wherein FIG. 4 is taken from view 4-4 in FIG. 1 being the overhead elevation view, FIG. 4 shows the external environment 55, the plant 60, the elastic band 185, the flexible surrounding sidewall 70, the longitudinal axis 75 for the sidewall 70, the outer 105 and inner 110 surfaces of the sidewall 70, the first 90 and second 95 margins removably engagable 125 to one another, with the extension element 145 that is operational to support 180 the sidewall 70, also noting that the first aperture 130 is in a open state 134.

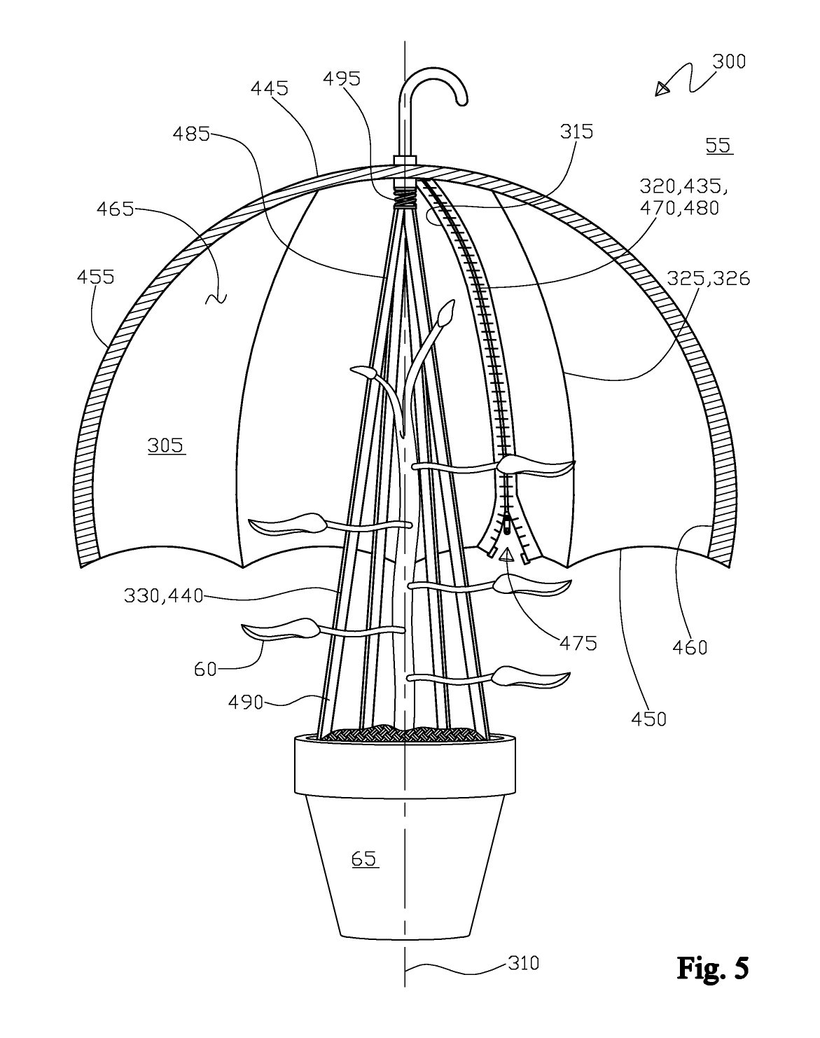

Next, FIG. 5 shows a side elevation view of a first alternative embodiment 300 of the planter cover apparatus that shows the external environment 55 the plant 60, the pot 65, a partial sidewall 305, a longwise axis 310, wherein the partial sidewall 305 includes a primary margin 315 and a secondary margin 320 that are removably engagable to one another in a closed state, further a beam 325 is shown that supports the partial sidewall 305, and a support structure 330 from the pot 65 to the partial sidewall 305.

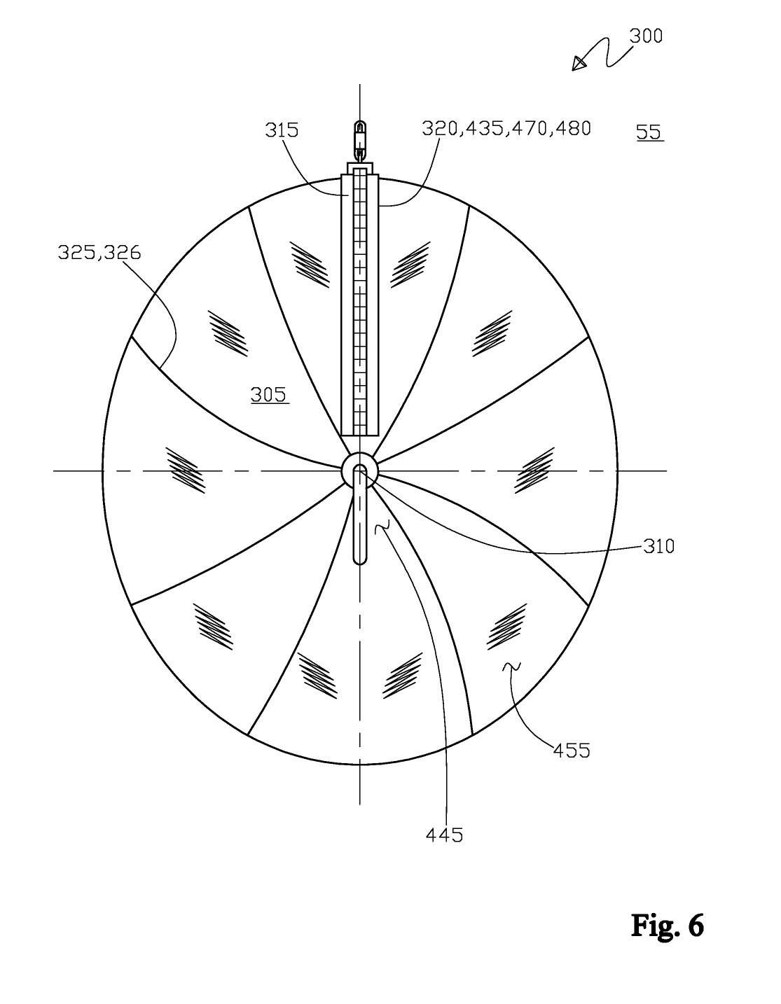

Yet further, FIG. 6 shows an upper elevation view of the first alternative embodiment 300 of the planter cover apparatus that shows the external environment 55 the plant 60, the pot 65, the partial sidewall 305, the longwise axis 310, wherein the partial sidewall 305 includes the primary margin 315 and the secondary margin 320 that are removably engagable to one another in the closed state, further the beam 325 is shown that supports the partial sidewall 305.

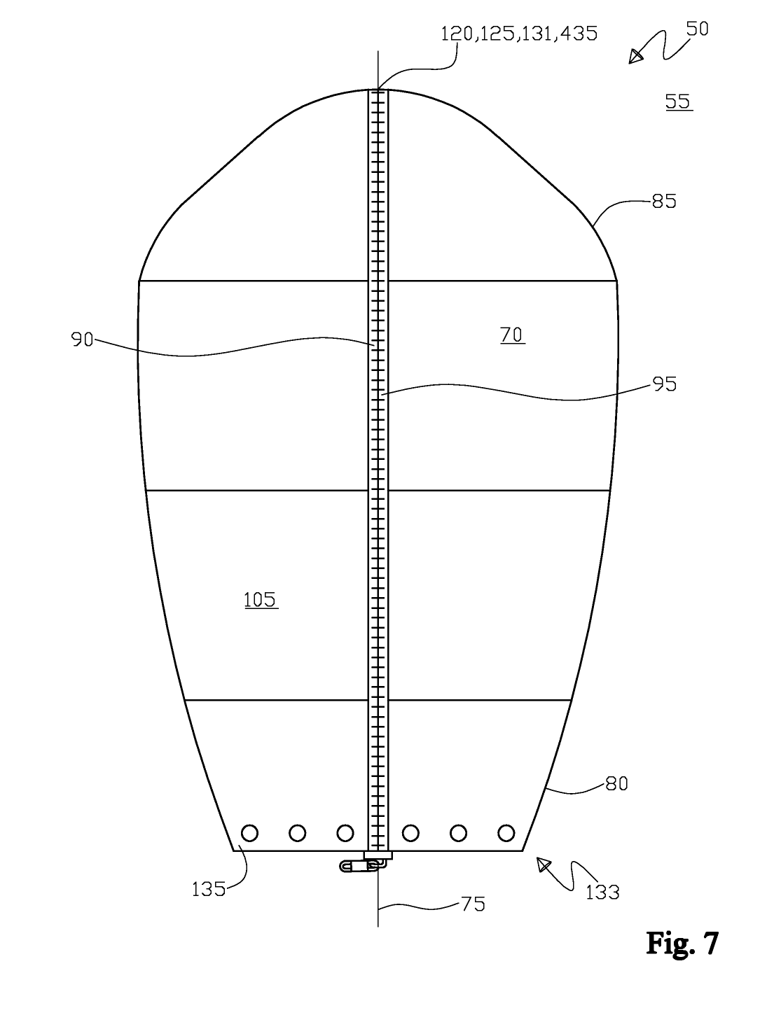

Continuing, FIG. 7 shows a side elevation view of the planter cover apparatus 50 that shows the external environment 55, the flexible surrounding sidewall 70, the longitudinal axis 75 for the sidewall 70, the outer surface 105 of the sidewall 70, the first 90 and second 95 margins that are removably engagable 125 to one another shown in the closed state 131, also noting that the first aperture 130 is in a closed state 131.

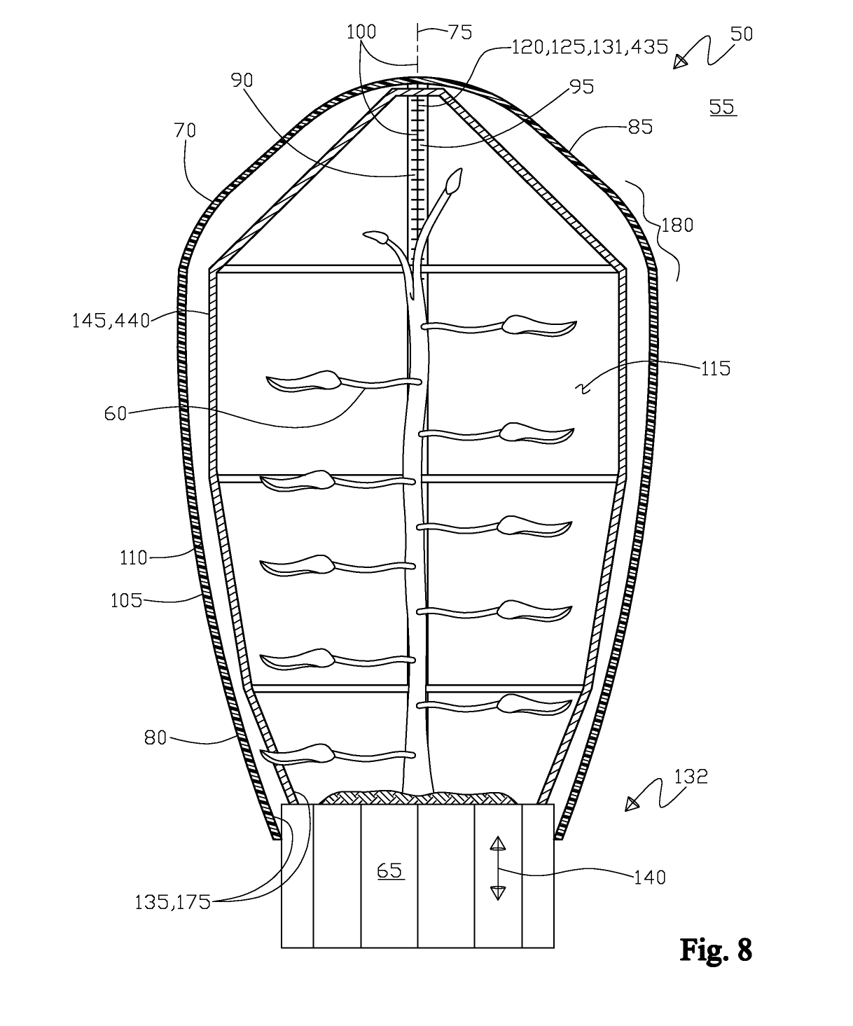

Further, FIG. 8 shows a side elevation cross sectional view of the planter cover apparatus 50 as shown in FIG. 7, wherein the FIG. 8 cross section shows the external environment 55, the plant 60, the pot 65, the flexible surrounding sidewall 70, the longitudinal axis 75 for the sidewall 90, the inner surface 110 and the outer surface 105 of the sidewall 70, the primary interior 115 of the sidewall 70, first 90 and second 95 margins removably engagable 125 to one another in the closed state 131, with the extension element 145 that is operational to support 180 the sidewall 70, also noting that the first 130 and second 135 apertures are in the closed state 131, 132.

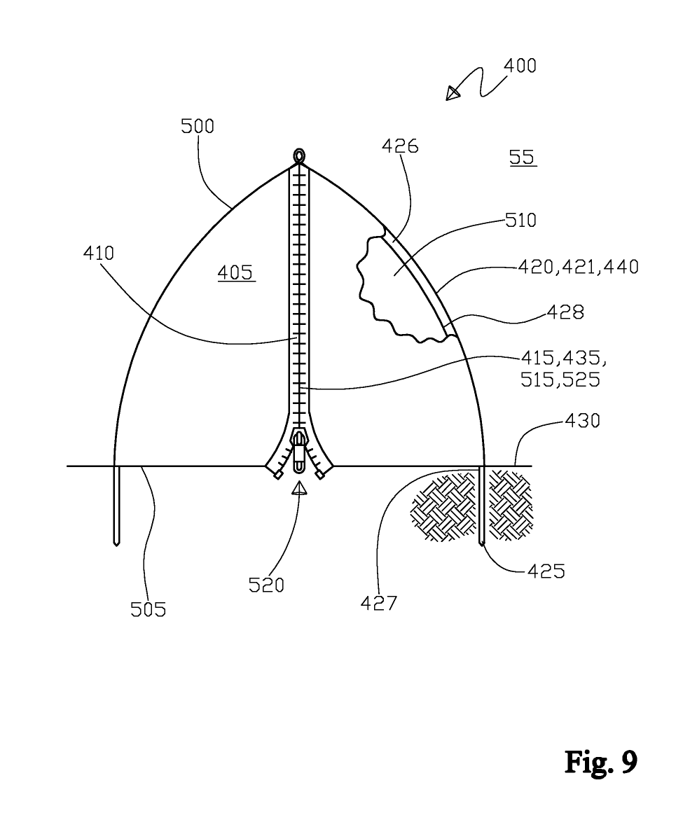

Next, FIG. 9 shows a side elevation view of a second alternative embodiment 400 of the planter cover apparatus that shows the external environment 55, a flexible wall 405, wherein the flexible wall 405 includes a leading margin 410 and a trailing margin 415 that are removably engagable to one another shown in a closed state, further a support element 420 is shown that supports the flexible wall 405 , and ground stakes 425 inserted into a ground surface 430.

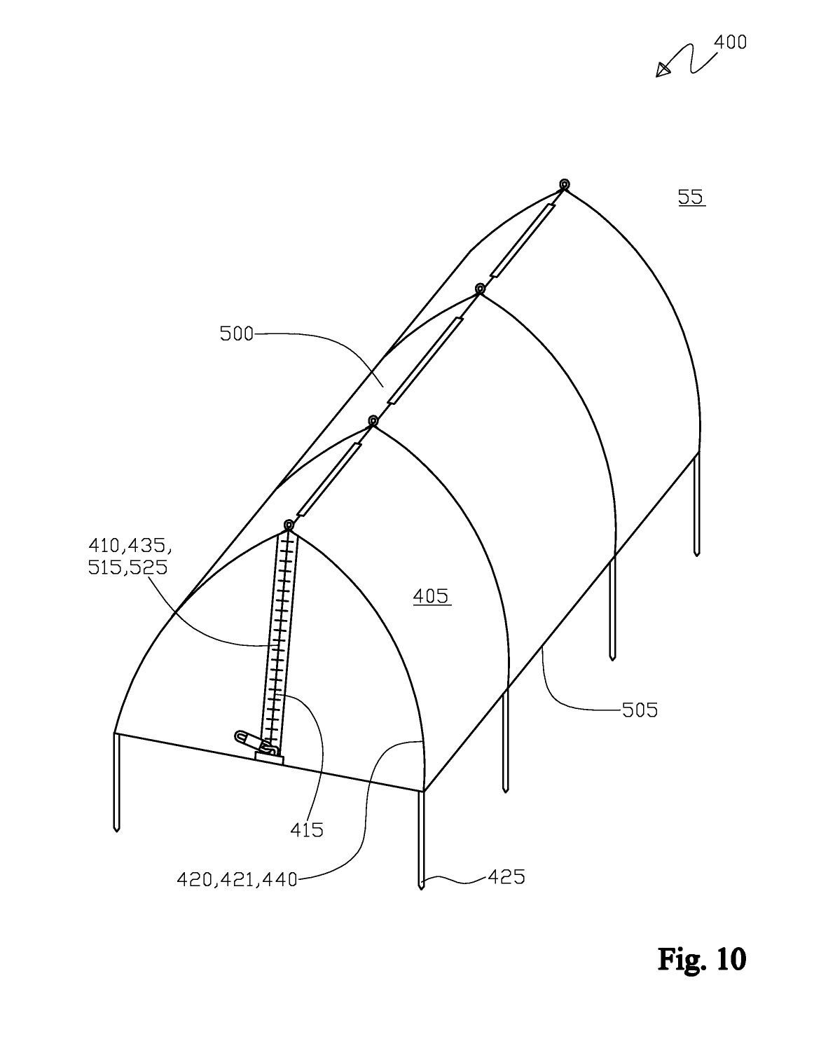

Continuing, FIG. 10 shows an upper perspective elevation view of the second alternative embodiment 400 of the planter cover apparatus that shows the external environment 55, the flexible wall 405, wherein the flexible wall 405 includes the leading margin 410 and the trailing margin 415 that are removably engagable to one another shown in the closed state, further the support element 420 is shown that supports the flexible wall 405, and ground stakes 425 inserted into the ground surface 430.

Broadly in looking at FIGS. 1 to 4, the present invention is the planter cover apparatus 50 for the plant 60 with the pot 65, wherein the apparatus 50 includes the flexible surrounding sidewall 70 that is about the longitudinal axis 75, wherein the surrounding sidewall 70 has a first end portion 80 and an opposing second end portion 85 with the longitudinal axis 75 spanning therebetween. The surrounding sidewall 70 also having the first margin portion 90 and the opposing second margin portion 95, wherein the first 90 and second 95 margin portions are substantially parallel 100 to the longitudinal axis 75, the surrounding sidewall 70 also having the outer surface portion 105 that is adjacent to the external environment 55 and the inner surface portion 110 that defines the primary interior 115 formed by the sidewall 70, the second end portion 85, and the first 90 and second 95 margins, see in particular FIGS. 1 and 2.

Wherein the outer surface portion 105 is attached at the second end portion 85 further forming the primary interior 115 that the plant 60 is disposed within, the first 90 and second 95 margin portions are removably engagable 125 to one another and define the first aperture opening 130 in the open state 134, further the second aperture 135 is disposed therethrough the first end portion 80 sidewall 70 allowing the pot 65 to pass therethrough 140, 205 from the primary interior 115 into the external environment 55, when the second aperture 135 is in a second aperture 135 open state 133, as best shown in FIGS. 1 and 2.

Also included on the planter cover apparatus 50 is the extension element 145 having a lengthwise axis 150, the extension element 145 having a proximal end portion 155 and an opposing distal end portion 160 with the lengthwise axis 150 spanning therebetween, see FIGS. 1 to 4. The extension element 145 is affixed 165 to the flexible surrounding sidewall 70 as between the flexible surrounding sidewall 70 first end portion 80 at the proximal end portion 155 and the extension element 145 is also affixed 170 at the flexible surrounding sidewall 70 second end portion 85 at the distal end portion 160, as best shown in FIGS. 1 and 2, also see FIGS. 3 and 4, further the proximal end portion 155 is secured 175 adjacent to the pot 65, see in particular FIGS. 1 and 2.

Further included in the planter cover apparatus 50 is the elastic band 185 that is affixed 190 to the flexible surrounding sidewall 70 first end portion 80 wherein the elastic band 185 extends outward 195 from the first end portion 80, see FIGS. 1 and 2. Wherein operationally, the elastic band 185 removably engages 200 the pot 65 and the extension element 145 provides support 180 for the flexible surrounding sidewall 70 about the plant 60 resulting in assisting in protection of the plant 60 from adverse weather, such as hard rain, high winds, snow, and hailstones in the external environment 55, further operationally the cover apparatus 50 is removable 210 from the plant 60 via the first aperture 130 in the open state 134 or the second aperture 135 in the open state 133, see FIGS. 1, 2, and 4.

As an option for the planter cover 50, the first 90 and second 95 margin portions being removably engagable to one another can preferably have removable engagable structure 435 that is selected from the group consisting essentially of a zipper, as shown in FIGS. 1 to 4, also a hook and loop fastener, buckles, lace-up, snap-in connectors, buttons, ties, snaps, double “D” rinds, hooks, and a groove and ridge interlock fastener or other suitable equivalent could be used.

Another option for the planter cover 50, can be that the extension element 145 is preferably constructed of an elongated beam 440 having a cross section that is selected from the group consisting essentially of an angle beam, as shown in FIGS. 1 and 2, also a channel beam, “I” beam, solid rod, and tube or any other suitable equivalent could be used.

A further option for the planter cover 50, is where the flexible surrounding sidewall 70 is preferably constructed of a transparent material to operationally transmit light for the plant 60 and to allow identification of the plant 60 with the planter cover apparatus 50 in place, as shown in FIGS. 1 to 3.

Looking at FIGS. 5 and 6 in particular, for the first alternate embodiment of the planter cover apparatus 300 for the plant 60 with the pot 65, the apparatus 300 includes a flexible partial surrounding sidewall 305 that is about the longwise axis 310, wherein the partial surrounding sidewall 305 has the closed end portion 445 and the opposing open end portion 450, wherein the longwise axis 310 is spanning therebetween. The partial surrounding sidewall 305 also having the primary margin portion 315 and an opposing secondary margin portion 320, wherein the primary 315 and secondary 320 margin portions are substantially parallel to the longwise axis 310 and have removably engagable structure 435 disposed therebetween, the partial surrounding sidewall 305 also having the outer surface portion 455 that is adjacent to the external environment 55 and the inner surface portion 460 that defines the partial interior 465 formed by the partial sidewall 305, the closed end portion 445, and the open end portion 450, wherein the primary 315 and secondary 320 margin portions are removably engagable 435 to one another and define the third aperture opening 470 in the third aperture 470 open state 475 and closed state 480 as shown in FIGS. 5 and 6.

Continuing for the first alternate embodiment of the planter cover apparatus 300 as shown in FIGS. 5 and 6, also included is the support structure 330 that runs substantially parallel to the longwise axis 310, the support structure 330 having the proximal end portion 485 and the opposing distal end portion 490 with the longwise axis 310 spanning substantially therebetween. The support structure 330 is affixed to the closed end portion 445 of the flexible partial surrounding sidewall 305, further the distal end portion 490 is secured adjacent to the pot 65, wherein operationally the open end portion 450 of the partial sidewall 305 is suspended over and above the pot 65 via the support structure 330 to provide a hood type protection for the plant 60. Further included in the first alternate embodiment of the planter cover apparatus 300 as shown in FIGS. 5 and 6, is the beam 325 is affixed 326 to the partial sidewall 305 to help support the dome shape of the partial sidewall 305.

As an option for the alternate embodiment of the planter cover apparatus 300, the primary 315 and secondary 320 margin portions being removably engagable 435 to one another have removably engagable structure 435 that is preferably selected from the group consisting essentially of a zipper, as shown in FIGS. 5 and 6, the hook and loop fastener, buckles, lace-up, snap-in connectors, buttons, ties, snaps, double “D” rinds, hooks, and the groove and ridge interlock fastener, and any other suitable equivalents could be used.

As another option for the alternate embodiment of the planter cover apparatus 300, wherein the support structure 330 and beam 325 are preferably constructed of an elongated beam having a cross section that is selected from the group consisting essentially of an angle beam, as shown for the support structure 330 in FIGS. 5 and 6, a channel beam, “I” beam, solid rod, and tube, or any other suitable equivalent could be used.

As a continuing option for the alternate embodiment of the planter cover apparatus 300, for the flexible partial surrounding sidewall 305 is preferably constructed of a transparent material to operationally transmit light for the plant 60 and to allow identification of the plant 60 with the alternative embodiment planter cover apparatus 300 in place.

As yet another option for the alternate embodiment of the planter cover apparatus 300, can further comprise a flexible element 495 disposed between the support structure 330 proximal end portion 485 and the closed end portion 445 of the flexible partial surrounding sidewall 305 to operationally allow the partial surrounding sidewall 305 to deflect in wind to reduce disturbing the support structure 330. The flexible element 495 is preferably a spring, but could be any resilient flexible element that is suitable for the use.

In looking at FIGS. 9 and 10, the second alternative embodiment planter cover apparatus 400 for the plant 60 is shown that is adjacent to the ground surface 430, with the second alternative embodiment planter cover apparatus 400 that includes the flexible wall 405 forming the dome shape, wherein the flexible wall 405 has the closed end portion 500 and the opposing open end portion 505. The flexible wall 405 also having the leading margin portion 410 and the trailing margin portion 415, wherein the leading 410 and trailing 415 margin portions are substantially disposed between the closed end portion 500 and the open end portion 505 of the flexible wall 405, and have removably engagable structure 435 disposed therebetween. The flexible wall 405 defines the dome interior 510 formed by the closed end portion 500 and the open end portion 505, wherein the leading 410 and trailing 415 margin portions are removably engagable 435 to one another and define the fourth aperture 515 opening in the fourth aperture 515 open state 520 with the closed state 525 shown also in FIGS. 9 and 10.

Also the second alternative embodiment planter cover apparatus 400 includes the frame structure 421 that runs from the flexible wall 405 open end portion 505 to the flexible wall 405 closed end portion 500, the frame structure 421 having the proximal end portion 426 and the opposing distal end portion 427, the frame structure 421 is also affixed 428 to the flexible wall 405, wherein operationally the frame structure 421 helps maintain the flexible wall 405 dome shape that is suspended over the plant 60 on the ground surface 430, as shown in FIGS. 9 and 10.

An option for the second alternative embodiment planter cover apparatus 400, can be wherein the leading 410 and trailing 415 margin portions being removably engagable 435 to one another have removably engagable structure 435 that is selected from the group consisting essentially of a zipper, as shown in FIGS. 9 and 10, the hook and loop fastener, buckles, lace-up, snap-in connectors, buttons, ties, snaps, double “D” rinds, hooks, and the groove and ridge interlock fastener, or any other suitable equivalent could be used.

Another option for the second alternative embodiment planter cover apparatus 400, is wherein the frame structure 421 is preferably constructed of an elongated beam 440 having a cross section that is selected from the group consisting essentially of an angle beam, a channel beam, “I” beam, solid rod, as shown in FIGS. 9 and 10, and tube, or any other suitable equivalent could be used.

A further option for the second alternative embodiment planter cover apparatus 400, wherein the flexible wall 405 is preferably constructed of a transparent material to operationally transmit light for the plant 60 and to allow identification of the plant 60 with the second alternative embodiment planter cover apparatus 400 in place, as shown in FIGS. 9 and 10.

Yet another option for the second alternative embodiment planter cover apparatus 400, wherein the frame structure 421 distal end portion 427 can further comprise the ground stake extension 425 to operationally help anchor the second alternative embodiment planter cover apparatus 400 to the ground surface 430.

### CONCLUSION

Accordingly, the present invention of a planter cover apparatus has been described with some degree of particularity directed to the embodiments of the present invention. It should be appreciated, though; that the present invention is defined by the following claim construed in light of the prior art so modifications of the changes may be made to the exemplary embodiments of the present invention without departing from the inventive concepts contained therein.

1. A planter cover apparatus for a plant with a pot, said apparatus comprising:
(a) a flexible surrounding sidewall that is about a longitudinal axis, wherein said surrounding sidewall has a first end portion and an opposing second end portion wherein said longitudinal axis spanning therebetween, said surrounding sidewall also having a first margin portion and an opposing second margin portion, wherein said first and second margin portions are substantially parallel to said longitudinal axis and have removably engagable structure disposed therebetween, said surrounding sidewall also having an outer surface portion that is adjacent to an external environment and an inner surface portion that defines a primary interior formed by said sidewall, said second end portion, and said first and second margins, wherein said outer surface portion is attached at said second end portion via said removably engagable structure further forming said primary interior that the plant is disposed within, wherein said first and second margin portions are removably engagable to one another and define a first aperture opening in a first aperture open state, further a second aperture is disposed therethrough said first end portion sidewall allowing the pot to pass therethrough from the said primary interior into the external environment when said second aperture is in a second aperture open state;
(b) an extension element having a lengthwise axis, said extension element having a proximal end portion and an opposing distal end portion with said lengthwise axis spanning therebetween, said extension element is affixed to said flexible surrounding sidewall as between said flexible surrounding sidewall first end portion at said proximal end portion and said flexible surrounding sidewall second end portion at said distal end portion, further said proximal end portion is secured adjacent to the pot; and
(c) an elastic band that is affixed to said flexible surrounding sidewall first end portion wherein said elastic band extends outward from said first end portion, wherein operationally said elastic band removably engages the pot and said extension element provides support for said flexible surrounding sidewall about the plant resulting in assisting in protection of the plant from adverse weather in the external environment, further operationally said cover apparatus is removable from the plant via said first aperture or said second aperture.

2. A planter cover according to claim 1 wherein said first and second margin portions being removably engagable to one another have removable engagable structure that is selected from the group consisting essentially of a zipper, a hook and loop fastener, buckles, lace-up, snap-in connectors, buttons, ties, snaps, double “D” rings, hooks, and a groove and ridge interlock fastener.

3. A planter cover according to claim 1 wherein said extension element is constructed of an elongated beam having a cross section that is selected from the group consisting essentially of an angle beam, a channel beam, “I” beam, solid rod, and tube.

4. A planter cover according to claim 1 wherein said flexible surrounding sidewall is constructed of a transparent material to operationally transmit light for the plant and to allow identification of the plant with said planter cover apparatus in place.

5. A planter cover apparatus for a plant with a pot, said apparatus comprising:
(a) a flexible partial surrounding sidewall that is about a longwise axis, wherein said partial surrounding sidewall has a closed end portion and an opposing open end portion wherein said longwise axis spanning therebetween, said surrounding sidewall also having a primary margin portion and an opposing secondary margin portion, wherein said primary and secondary margin portions are substantially parallel to said longwise axis and have removably engagable structure disposed therebetween, said partial surrounding sidewall also having an outer surface portion that is adjacent to an external environment and an inner surface portion that defines a partial interior formed by said partial sidewall, said closed end portion, and said open end portion, wherein said primary and secondary margin portions are removably engagable to one another and define a third aperture opening in a third aperture open state;
(b) a support structure that runs substantially parallel to said longwise axis, said support structure having a proximal end portion and an opposing distal end portion with said longwise axis spanning substantially therebetween, said support structure is affixed to said closed end portion of said flexible partial surrounding sidewall, further said distal end portion is secured adjacent to the pot, wherein operationally said open end portion of said flexible partial surrounding sidewall is suspended over and above the pot via said support structure to provide a dome hood type protection for the plant; and
(c) a beam that is affixed to said flexible partial surrounding sidewall that is operational to help form said dome hood of said flexible partial surrounding sidewall.

6. A planter cover according to claim 5 wherein said primary and secondary margin portions being removably engagable to one another have removably engagable structure that is selected from the group consisting essentially of a zipper, a hook and loop fastener, buckles, lace-up, snap-in connectors, buttons, ties, snaps, double “D” rings, hooks, and a groove and ridge interlock fastener.

7. A planter cover according to claim 5 wherein said support structure is constructed of an elongated beam having a cross section that is selected from the group consisting essentially of an angle beam, a channel beam, “I” beam, solid rod, and tube.

8. A planter cover according to claim 5 wherein said flexible partial surrounding sidewall is constructed of a transparent material to operationally transmit light for the plant and to allow identification of the plant with said planter cover apparatus in place.

9. A planter cover according to claim 7 further comprising an flexible element disposed between said support structure proximal end portion and said closed end portion of said flexible partial surrounding sidewall to operationally allow said partial surrounding sidewall to deflect in wind to reduce disturbing said support structure.

10. A planter cover apparatus for a plant that is adjacent to a ground surface, said apparatus comprising:
(a) a flexible wall forming a dome shape, wherein said flexible wall has a closed end portion and an opposing open end portion, said flexible wall also having a leading margin portion and an trailing margin portion, wherein said leading and trailing margin portions are substantially disposed between said closed end portion and said open end portion of said flexible wall, and have removably engagable structure disposed therebetween, said flexible wall defines a dome interior formed by said closed end portion and said open end portion, wherein said leading and trailing margin portions are removably engagable to one another and define a fourth aperture opening in a fourth aperture open state; and
(b) a frame structure that runs from said flexible wall open end portion to said flexible wall closed end portion, said frame structure having a proximal end portion and an opposing distal end portion, said frame structure is affixed to said flexible wall, wherein operationally said frame structure helps maintain said flexible wall dome shape that is suspended over the plant.

11. A planter cover according to claim 10 wherein said leading and trailing margin portions being removably engagable to one another have removably engagable structure that is selected from the group consisting essentially of a zipper, a hook and loop fastener, buckles, lace-up, snap-in connectors, buttons, ties, snaps, double “D” rings, hooks, and a groove and ridge interlock fastener.

12. A planter cover according to claim 10 wherein said frame structure is constructed of an elongated beam having a cross section that is selected from the group consisting essentially of an angle beam, a channel beam, “I” beam, solid rod, and tube.

13. A planter cover according to claim 10 wherein said flexible wall is constructed of a transparent material to operationally transmit light for the plant and to allow identification of the plant with said planter cover apparatus in place.

14. A planter cover according to claim 10 wherein said frame structure distal end portion further comprises a ground stake extension to operationally help anchor said planter cover to the ground surface.
